(19) United States
(12) Patent Application Publication
(10) Pub. No.: US 2005/0111223 A1
(43) Pub. Date: May 26, 2005

(54) Worklight with aimable head

(76) Inventors: Wade Lee, Danville, CA (US); Donald R. Sandell, San Jose, CA (US)

Correspondence Address: ELLIOT B. ARONSON, 5001 HARBORD DRIVE, OAKLAND, CA, 94618, US

(21) Appl. No.: 11/044,669

(22) Filed: Jan. 26, 2005

(51) Int. Cl. F21V 21/26

(52) U.S. Cl. 362/269

(57) ABSTRACT

A worklight with a detent mechanism for aiming the worklight head in a direction of the user's choice. The detent mechanism is operatively associated with an individual worklight head and defines a plurality of fixed detent positions disposed to maintain the head in a plurality of angular dispositions corresponding to different angles of rotation about an axis. The head is movable between the fixed detent positions for aiming in a desired direction, the detent mechanism being biased to maintain the head in the fixed detent positions at the desired angular disposition against the weight of the head itself, the pull of the electrical cord, and in those cases where the head gets hot, against the tendency of the head to droop under the action of heat and thereby to prevent unintentional shifting of the head during use.

### BACKGROUND OF THE INVENTION

The present invention relates to worklights and is more particularly directed to arrangements for aiming a worklight in a desired direction.

Worklights have become popular for use in such varied settings as construction jobs, industrial plants, automotive and auto body repair shops, artist and photographic studios, and projects around the home. A typical worklight has one or two, or sometimes more, worklight heads that are supported on a base. The base is typically formed so that it can be set on the ground or on a work surface or it is often formed for mounting on a tripod. In some models a worklight head is attached to a spring clamp so that the light can be clamped in position on some other support member. Once the worklight is set in position, it is generally necessary to aim the one or more individual heads to illuminate the desired area. Worklight heads have conventionally been aimed by loosening one or more locking knobs, turning the head to point in the desired direction, and then re-tightening the locking knobs. This can be inconvenient because there is often not much space available to grasp the knob to loosen it or especially to tighten it with one hand while the head is held in position with the other hand. In halogen worklights especially this procedure is less than ideal because halogen lamps operate at a sufficiently high temperature that the worklight head can get hot enough to cause a burn if touched. This places greater demand on the location of the adjustment knobs and their proximity to the hot surfaces of the worklight head. In addition, larger halogen worklight heads, for example 500 Watt heads, can be subject to head droop during use. The heads are held in position by frictional engagement under the action of the locking knobs. The knobs are typically fabricated of plastic and the friction may also be intermediated through plastic washers or other plastic components. The heat from a large head, however, can cause the otherwise hard plastic friction surfaces of the knob or other components to soften. The locking knob in effect is caused to loosen slightly, and the extra weight of the large head causes the head to slip slightly, that is, to droop.

To gain a greater appreciation of the invention, it is beneficial first to describe in more detail the nature of the conventional method for aiming a worklight head. FIG. 1 shows an overall view of a dual-head halogen worklight of the prior art comprising a pair of worklight heads 10 that are mounted on a supporting stand indicated generally at 11 that comprises a crossbar 12, to which the heads are attached, and tubular feet 13 for engaging the work surface. The head defines a light bulb chamber typically with reflecting interior walls and a window 14 for the light to pass through. Two halogen bulbs 16 are shown in each chamber, and a protective guard 17 extends out in front of each chamber.

Each head 10 is secured to crossbar 12 through an intermediate support member, here provided by mounting bracket 21. The bracket is releasably held in place through knob 22, which is on a threaded shaft that screws into crossbar 12. The knob is screwed down tight to hold the bracket securely against the crossbar. On the underside of the head are two projecting tabs 23 for attaching the bracket to the head. Attitude adjustment knobs 24 are attached to threaded shafts that extend through the bracket and screw into the tabs 23. The knobs 24 have spacer sections 26 to space the knob away from the head so that the user can turn the knob without touching the head so as to avoid getting burned. Friction washers are sometimes used between bracket 21 and an engaging tab 23 to hold the head more securely. To adjust the attitude of the head, that is, the forward and back tilt of the head, the two knobs 24 on a head are loosened, the head is tilted by grasping the handle 27 and urging the head to the desired angle, and the knobs 24 are re-tightened. Similarly, to pivot the light about its vertical axis, knob 22 is loosened, the light is turned by means of handle 27, and knob 22 is re-tightened.

It can now be appreciated that in carrying out this procedure the user necessarily has to manipulate the knob with his or her hand in close proximity to the hot surfaces of the worklight head. It is, of course, possible to provide more room by extending the spacer sections 26 and lengthening the sides of bracket 21, but this leads to a bulkier worklight, and knobs 24 are more prone to breakage due to the longer effective lever arm provided by the extended spacer section.

It can now also be appreciated that the head is held in position by the frictional engagement of bracket 21 with tab 23, perhaps intermediated through a washer against the force of gravity continually pressing to turn the head about the axis of the knobs 24. For heads pointed sufficiently downward the weight of guard 17 and front frame member 28 urges the head to pivot forward, and the head is held in place only by the friction of the knobs 24. For heads angled upward, or even held level, the weight of the rear portion of the head urges the head to pivot backward, again the head being held in place only by the friction of the knobs 24. Moreover, the electrical cord 29 that supplies electrical power to the heads may pull on the heads under conditions of use in the work environment, which can move the heads out of aim. Under the heat generated by the halogen lamps and passed to the frictional surfaces by the housing body, plastic components soften and the head yields to the always present gravitational force and to the push and pull of the electrical cord turning the head one way or the other about the knob axis; that is, the heads tend to “droop” or shift when they get hot.

The present invention provides an alternative to the conventional mechanism for aiming the worklight head that greatly overcomes the above problems and disadvantages.

### SUMMARY OF THE INVENTION

The present invention provides a worklight with an improved mechanism for aiming the worklight head in a direction of the user's choice. A worklight incorporating the invention typically includes at least one worklight head mounted so as to be rotatable about an axis for aiming the head in the desired direction. The individual heads are of some heft, weighing at least about 1.5 pounds (about 0.68 kg) and have an electrical cord attached to them for connection to a source of electrical power (typically at 115 or 220 Volts) for powering halogen, fluorescent or other form of lamp or lamps in the head. Briefly, the invention provides a detent mechanism operatively associated with an individual head that defines a plurality of fixed detent positions disposed to maintain the head in a plurality of angular dispositions corresponding to different angles of rotation about an axis. The head is movable between the fixed detent positions for aiming in a desired direction, the detent mechanism being biased to maintain the head in the fixed detent positions at the desired angular disposition against the weight of the head itself, the pull of the electrical cord, and in those cases where the head gets hot, against the tendency of the head to droop under the action of heat and thereby to prevent unintentional shifting of the head during use.

In one embodiment of the invention the detent mechanism is deployed in a worklight in which the head is mounted on a support so as to be rotatable about a nominal horizontal axis for aiming the head in a desired up-and-down direction. The support may take the form of a conventional U-shaped bracket such as commonly used with worklight heads, or other forms of support may be used. The detent mechanism is operates between with the head and the support, and the plurality of fixed detent positions are disposed to maintain the head in a plurality of up-and-down attitudes with respect to the nominal horizontal axis. In another embodiment of the invention the detent mechanism is deployed in a worklight in which the head is mounted on an intermediate member, which is itself mounted on a further support so as to be rotatable about a nominal vertical axis for aiming the head in a desired side-to-side direction. The commonly used U-shaped mounting bracket mentioned above may serve as the intermediate member, which may be attached to a base support or other form of support for rotation about a nominal vertical axis through the midportion of the U-shaped bracket, although other arrangements may also be used. The detent mechanism then operates between the intermediate member and the support, and the plurality of fixed detent positions are disposed to maintain the head in a plurality of side-to-side angular dispositions corresponding to different angles of rotation with respect to the nominal vertical axis.

The worklight heads described here typically weigh at least about 1.5 pounds, and often more for the higher-wattage lights, and are intended to be used with the typical household electrical voltage (typically 115 V in the United States) and thus have an electrical cord attached to them for this purpose. The heads are described herein as weighing “about 1.5 pounds” to allow for the typical range of error encountered in household measurement of weights of this order of magnitude. Such heads are subject to having the aim disrupted through the action of the weight of the head, heat and/or pull of the electrical cord, and have not heretofore relied upon detent mechanisms for aiming.

Various designs of detent mechanisms are disclosed providing a variety of arrangements of detent positions.

Other aspects, advantages, and novel features of the invention are described below or will be readily apparent to those skilled in the art from the following specifications and drawings of illustrative embodiments.

### BRIEF DESCRIPTION OF THE DRAWINGS

FIG. 1 is an overall view of a worklight according to the prior art.

FIG. 2 is an overall view of a single-head worklight incorporating an embodiment of the invention.

FIG. 3 is an exploded view of an embodiment of detent mechanism in the worklight of FIG. 2.

FIG. 3A is an exploded view of an alternative embodiment of detent mechanism for achieving an increased number of fixed detent positions.

FIG. 4 is a cross-sectional view of an embodiment of the vertical detent mechanism of FIG. 3.

FIG. 5 is an exploded view of an embodiment of detent mechanism suitable for use with a removable head such as in a clamp light.

FIG. 5A is an overall perspective view, partially cut away, of an alternative embodiment of detent mechanism.

FIG. 6 is an exploded view showing an alternative embodiment of detent mechanism controlling the up-and-down tilt of a worklight head about a horizontal axis.

FIG. 6A is a fragmentary auxiliary view of the mechanism of FIG. 6.

### DETAILED DESCRIPTION OF ILLUSTRATIVE EMBODIMENTS

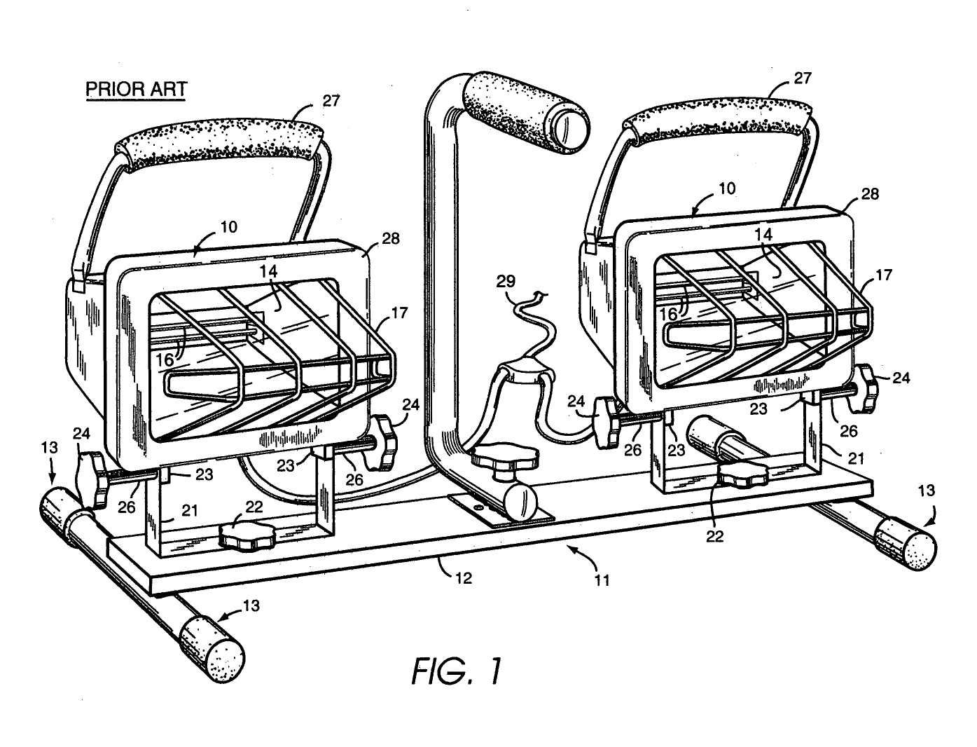

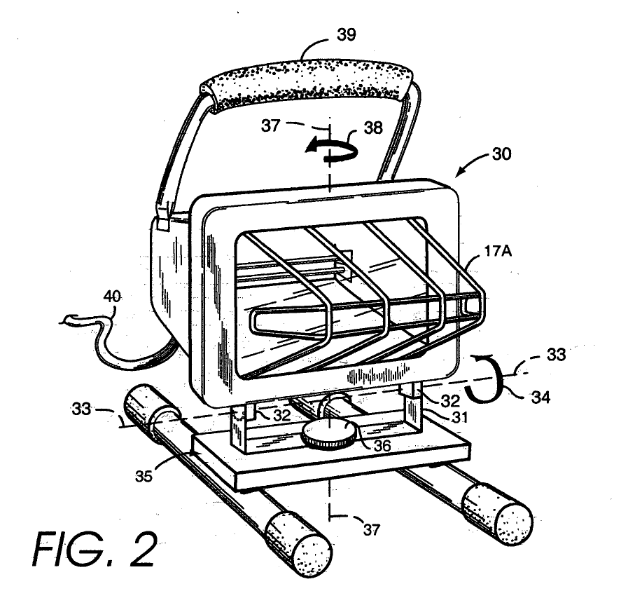

FIG. 2 provides an overall view of an embodiment of a worklight having a single worklight head 30 of the general type shown in the prior art worklight of FIG. 1. Head 30 is directly supported by a mounting bracket 31, which is rotatably attached at its ends to two downward projecting tabs 32 on the underside of the head. The two attachment points at the projecting tabs 32 are aligned so that the head can be rotated about an axis 33 through the attachment points, as indicated by arrow 34, to aim the head in a desired up-and-down attitude. The mounting bracket 31 shown in FIG. 2 is a conventional U-shaped bracket although, as will become apparent, the invention can readily be adapted to other forms of supporting brackets or other supporting structures.

Mounting bracket 31 is in turn mounted on a supporting base, which in the embodiment of FIG. 2 is a base stand 35 to be placed directly on a work surface, but could be any kind of support such as a simple cross bar or other arrangement for mounting on a tripod or a support member on a clamp as in a clamp light. Mounting bracket 31 is rotatably connected at its midportion to the base stand at the position of knob 36 so that the head can be rotated about the vertical axis 37 passing through knob 36 perpendicular to the base stand, as indicated by arrow 38, to aim the head in a desired side-to-side direction.

In general, a worklight according to the invention includes one or more detent mechanisms for aiming the head in a desired direction. Each detent mechanism defines a plurality of fixed detent positions disposed to maintain the head in a plurality of angular dispositions corresponding to different angles of rotation about an associated axis. Each detent mechanism is operatively associated with the head in the sense that manually turning the head causes the detent mechanism to move from one fixed position to another corresponding to the different fixed angular dispositions of the head. The worklight of FIG. 2 includes three detent mechanisms. Two cooperating detent mechanisms are disposed at the two projecting tabs 32 and operate between the head and mounting bracket 31, and the third is underneath knob 36 and operates between base stand 35 and mounting bracket 31, which acts as an intermediate member for securing the head to the base support 35.

For ease of discussion the axes 33 and 37 are referred to herein as the nominal horizontal axis and nominal vertical axis, respectively. “Horizontal” and “vertical” are used in the nominal sense to distinguish the up-and-down aiming direction (rotation about the nominal horizontal axis) and side-to-side aiming direction (rotation about the nominal vertical axis). The axes are horizontal and vertical in the sense that the worklight will generally define natural horizontal and vertical axes by virtue of either the overall form of the worklight or the normal position of the worklight in its intended configuration of use on a horizontal work surface or on a tripod. Some embodiments that can be used in a number of orientations—for example, a clamp worklight, in which a worklight head is mounted on a clamp that can be secured to a fixed supporting structure at any useful angle—will nevertheless define natural horizontal and vertical directions typically determined by the shape of the head or of the head support or both. Such clamp worklight heads generally have two independent directions in which they can be oriented and there is usually a naturally identified up-and-down and side-to-side direction. In any case, nominal horizontal and nominal vertical are introduced here merely as convenient terminology to distinguish the two independent directions of rotation, which need not even be strictly perpendicular to one another.

The detent mechanisms at the projecting tabs 32 define a plurality of fixed detent positions, which are disposed to maintain the head in a number of different up-and-down attitudes, that is to say, at a number of different angles of rotation about nominal horizontal axis 33. The detent mechanisms generally allow the head to be shifted from one detent position to another by grasping the handle 39 and tilting the head forward or back. The detent mechanism is biased so as to hold the head in the selected fixed detent position.

In the embodiment of FIG. 2 a separate detent mechanism is provided to control the pivoting of the head the about nominal vertical axis 37. This “vertical” detent mechanism is disposed beneath knob 36 and is not visible in FIG. 2. Like the horizontal mechanism, this detent mechanism also defines a number of fixed detent positions, which are now disposed to maintain the head in a number of side-to-side angular positions corresponding to different angles of rotation about the nominal vertical axis. This detent mechanism also permits the head to be shifted from one detent position to another by grasping the head by handle 39 and rotating gently about the vertical axis. The vertical detent mechanism is also biased to hold the intermediate member, here the mounting bracket 31, in the selected fixed detent position. These detent mechanisms are sufficiently structured and biased to hold the head in the selected horizontal and vertical positions against the weight of the head with its forwardly protruding guard 17A and rearwardly protruding rear portion and against the pulls and tugs of the electrical cord 40 that are commonly experienced under conditions of use, and also, where the head is of the halogen type that may become sufficiently hot to otherwise cause a drooping problem, to hold the head in its selected detent positions against any potential drooping action.

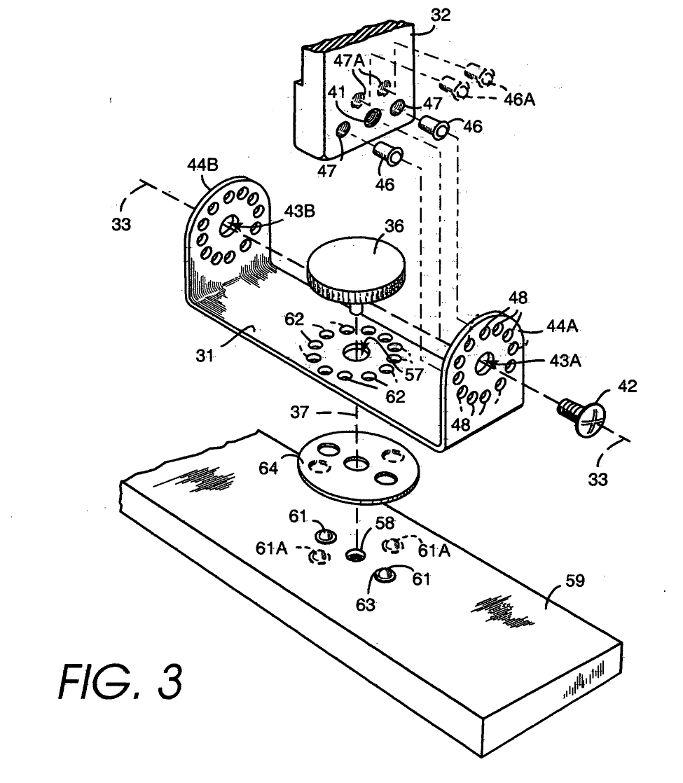

FIG. 3 shows an embodiment of both horizontal and vertical detent mechanisms from the worklight of FIG. 2. The horizontal mechanism will be described first. The downward projecting tab 32 has a mounting hole 41 that is tapped to receive a threaded screw 42, which extends through a centrally disposed hole 43A in a first vertical arm 44A of mounting bracket 31 to secure the bracket to the downward projection. Screw 42 is preferably a shoulder screw having a shoulder on the inner surface of the screw head that is roughly the same thickness as bracket arm 44A so as to prevent binding friction between projecting tab 32 and the mounting bracket when the screw is tightened and thereby facilitate rotation about the screw axis. The opposite mounting bracket arm 44B has a similarly positioned mounting hole 43B and mounting screw for attachment to the opposite downward projection (not shown). The co-linear support positions of the mounting screws and central holes 43A and 43B define the nominal horizontal axis 33. Mounted in the downward projecting tab 32 are one or more spring-biased detents. In FIG. 3 these are shown as spring-loaded plunger detents 46, more specifically, ball detents, although other forms of spring-loaded detents, such as pin-shaped plunger detents or other detents, could also be used. In FIG. 3 the spring-loaded ball detents are press-fit into or, alternatively, glued into bores 47 in the tabs. The vertical mounting bracket arm 44A is formed with a plurality of recesses 48 lying along a circular arc of an appropriate radius about the mounting hole so that recesses will lie in registration with the plungers of the detents as the head is rotated about axis 33. In FIG. 3 the recesses take the form of holes that go all the way through the mounting bracket arm. This is done for ease of manufacturing; in other embodiments the recesses could take the form of depressions that do not penetrate all the way through the bracket material.

FIG. 3 shows two spring-loaded ball detents 46 that both align with corresponding recesses on the bracket member for any fixed detent position. Two detents are used in this embodiment to provide greater holding power. In many applications, for example, with lighter heads, a single detent will suffice. The preferred number of detents active at any one detent position for any particular worklight embodiment will depend on such factors as the weight and weight distribution of the head and the nature of the individual detents; for any given embodiment the appropriate number of detents can readily be determined empirically.

As an alternative embodiment FIG. 3 shows two additional bores 47A (shown in phantom) in the downward projecting tab 32. These bores receive the two additional spring-loaded detents 46A, also shown in phantom, for defining additional fixed detent positions. The alternative bores are disposed at the same radius from axis 33 as bores 47 with an angular disposition about the nominal horizontal axis that is offset sufficiently from the other detents 46 so that when the other detents are in registration with corresponding recesses in the bracket arm, the alternative bores 47A will not be in position of registration with any of the recesses. Then rotating the head about the horizontal axis through a small angular displacement—smaller than the angular separation between two neighboring recesses—will bring the alternative two detents 46A into a position of registration with recesses. In this way, twice as many fixed the detent positions are defined as would be available with only the first pair of detents 46.

FIG. 3A shows an alternative embodiment for achieving an increased number of fixed detent positions. In the embodiment of FIG. 3A the intermediate bracket member is formed with a second set of recesses 51 along a second circular arc about axis 33 of a smaller (or larger) radius. The second set of recesses are angularly offset from the first circular arc of recesses 48. One or more supplemental detents 52 in projecting tab 32A at a comparable radius from the center point align with this second arc of recesses.

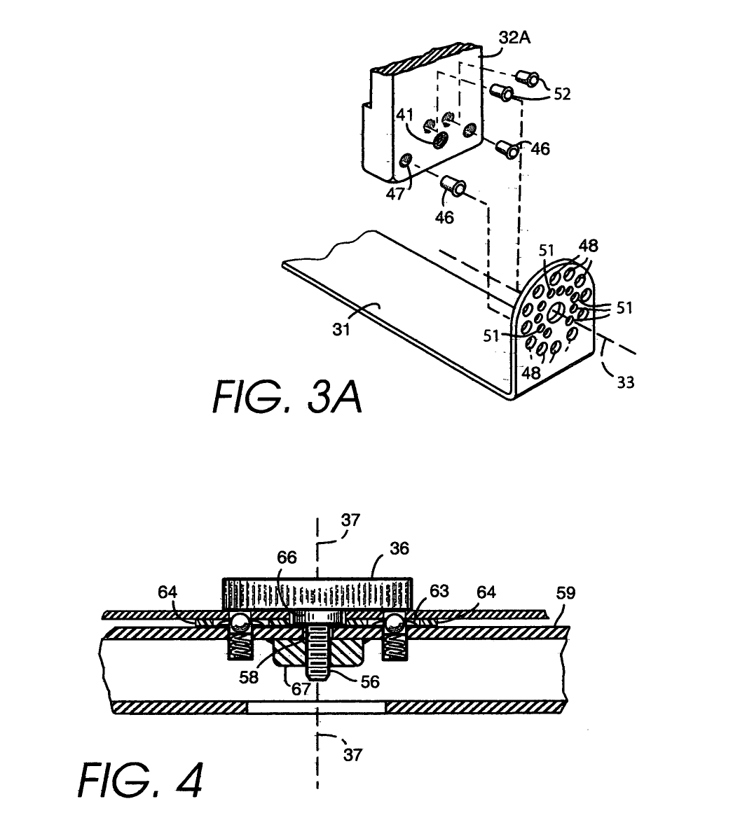

An embodiment of vertical detent mechanism is shown in FIGS. 3 and 4. The vertical mechanism of FIG. 3 operates much the same as the horizontal mechanism of FIG. 3. Knob 36 has a threaded shaft 56 that passes through a central hole 57 in mounting bracket 31 and into a receiving bore 58 in the underlying crossbar support 59. This secures the mounting bracket to the horizontal crossbar and allows the mounting bracket, hence the head, to rotate about vertical axis 37. One or more spring-loaded plunger detents 61 are mounted in the crossbar support by being press-fit or glued into the bores in the support. The horizontal portion of mounting bracket 31 is formed with a plurality of recesses 62 disposed in a circular arc in the horizontal portion of the bracket about the position of hole 57. Plunger detents 61 are disposed to align with horizontal recesses 62 as the head, and hence intermediate bracket 31, is rotated about nominal vertical axis 37. The bottom crossbar support member may also include supplemental offset plunger detents 61A, which are angularly offset to define a supplemental set of fixed detent positions. Here, too, the horizontal portion of the mounting bracket can be provided with a second set of circularly arranged detents along an arc of smaller or larger radius, which, together with a plunger detent positioned at the smaller or larger radius, define an alternative number of detent positions.

Plunger detents 61 extend above the surface of crossbar support 59 and into corresponding recesses 62 of the horizontal arm of mounting bracket 31. The individual detents shown in FIG. 3 have a small shoulder 63, which also extends above the surface of the crossbar support. A plastic spacer ring 64 is interposed between the mounting bracket and the crossbar support. This ring is approximately the thickness of the detent shoulder 63 and serves to reduce the friction between the mounting bracket and crossbar support surface as the head and mounting bracket 31 are pivoted about vertical axis 37.

FIG. 4 shows a cross-sectional view of the vertical detent mechanism of FIG. 3. In this embodiment crossbar support member 59 is seen to be hollow. Knob 36 is a shoulder knob having a shoulder portion 66 sized to hold the mounting bracket snugly on the crossbar support member 59 with allowance for the thickness of plastic intermediary spacer ring 64. In this embodiment threaded shaft 56 of shoulder knob 36 screws into a nut 67, which is welded to the inside surface of support member 59.

Shoulder knob 36 plays no role in the operation of the horizontal detent mechanism other than to hold the mounting bracket in its snug position on the crossbar support member so that detents 61 (and 61A, if employed) engage recesses 62. In particular, it is not necessary or desirable for the user to loosen the knob before pivoting the head about the vertical axis or to re-tighten the knob after the head has been aimed. For purposes of the detent mechanism a bolt or other securement devise could be used in place of the shoulder knob. The shoulder knob is provided here to enable the head and mounting bracket to be conveniently removed from the support member for repair, replacement or storage, and to permit a new worklight to be initially packed with its head(s) removed from the support member. This allows the worklight to be packaged in a smaller box, which is desirable for shipping and for stacking on shelves at the point of sale.

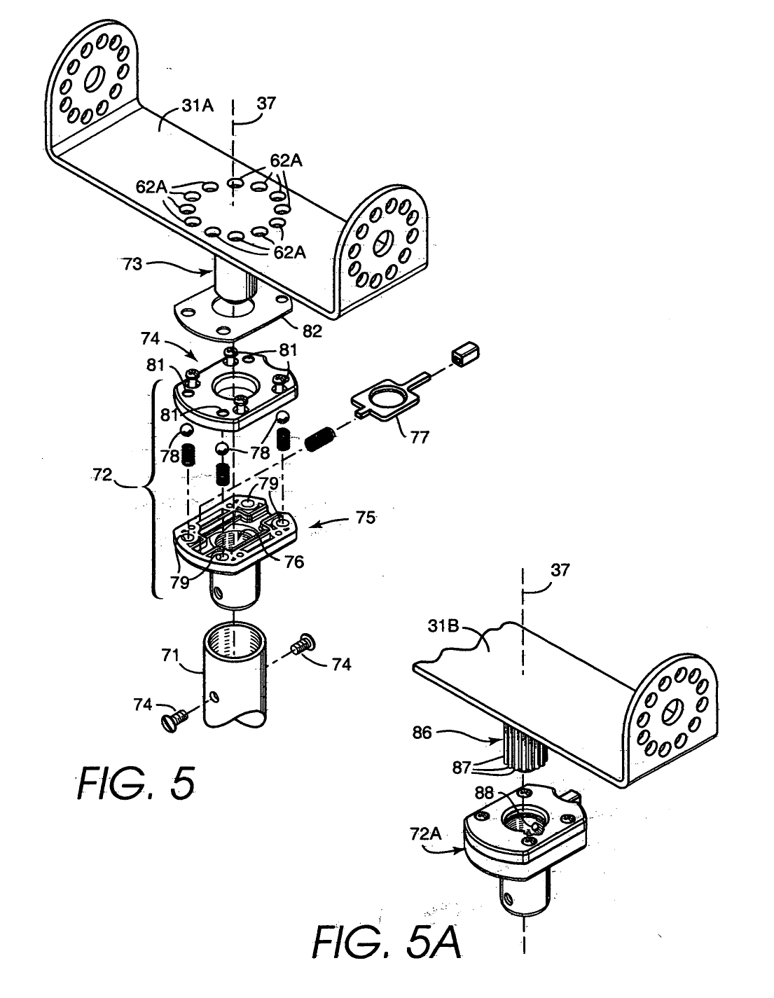

In some applications it is desirable to remove the head completely from its support in the course of using the worklight. For example, in one form of worklight a head is mounted on a clamp, which the user can then attach to a fixed support structure at the worksite. In one embodiment it is desirable to separate the head from the clamp, for example, to allow different size heads to be used or to attach the head to one end or the other of the clamp, that is, to attach the head to multiple connection spots on the clamp. FIG. 5 shows an embodiment providing a detent mechanism for a readily removable head suitable for use with a clamp light. The tubular member 71 represents a portion of a clamp to which the head is attached. For example, tubular member 71 may be attached at its lower end to a spring clamp or other form of clamp. A portion of the detent mechanism is incorporated into a removable receiver module, generally indicated at reference numeral 72, which receives the worklight head, in particular a stud 73 on the underside of intermediate mounting bracket 31A. The receiver module includes an upper portion 74 and a separate lower portion 75. A hole, indicated generally at reference numeral 76, is formed in the receiver module for receiving the stud. An actuator 77 is mounted in the receiver assembly for movement between a latching position and a release position. The stud and actuator are formed to engage one another in the latching position so as to hold the stud in the receiver module and thereby retain the worklight in position on the support 71. The structure and operation of the receiver module for attaching and detaching a worklight head to and from the tubing portion 71 are described in more detail in co-pending U.S. patent application Ser. No. 10/874,144 filed Jun. 21, 2004 entitled “Quick-Release Worklight Mounting,” the disclosure of which is incorporated herein by reference.

The detent mechanism in this embodiment includes spring-loaded ball detents 78, which are carried in bores 79 in lower receiver portion 75. The balls of the individual detents extend through corresponding bores 81 in upper receiver portion 74 and engage recesses 62A in intermediate mounting bracket 31A.

As described above, a circular arc of recesses is formed in the bottom of the horizontal arm of the mounting bracket 31. Extending from the center of the bottom arm of the mounting bracket is a shaft 73, which is inserted into bore 76 in the module 72. An optional thin plastic spacer member 82 may be introduced between the underside of bracket 31A and the upper surface of upper receiver portion 74 to reduce frictional contact between the surfaces and with the surface of the detent plunger shoulders as the head is rotated about nominal vertical axis 37. Spacer member 82 may also serve as a spacer in embodiments calling for clearance between the bottom of the bracket 31A and top of receiver assembly 72.

FIG. 5A shows an alternative embodiment in which the downwardly projecting shaft 86 at the bottom of the mounting bracket 31B is formed with a plurality of vertical ridges 87 that provide the detents. The ridges mate with a biased detent, which in the embodiment of FIG. 5A is provided by a spring-biased boss 88 (which has been somewhat enlarged in the figure for visibility), such as a plunger detent, located at the wall of the bore inside the receiver module, although other catch arrangements such as a pawl arrangement or several spring-biased plunger detents could also be used. Boss 88 is biased to normally extend into the interior of the bore. The ridged shaft on the mounting bracket is inserted into the bore, twisting it slightly as needed to allow the shaft to slide in and engage the boss or pawl. The fixed detent positions are then defined by the action of the boss or pawl engaging the grooves between the ridges. Although the ridged detents are illustrated here in a vertical detent mechanism, they may of course also be employed in a horizontal detent mechanism.

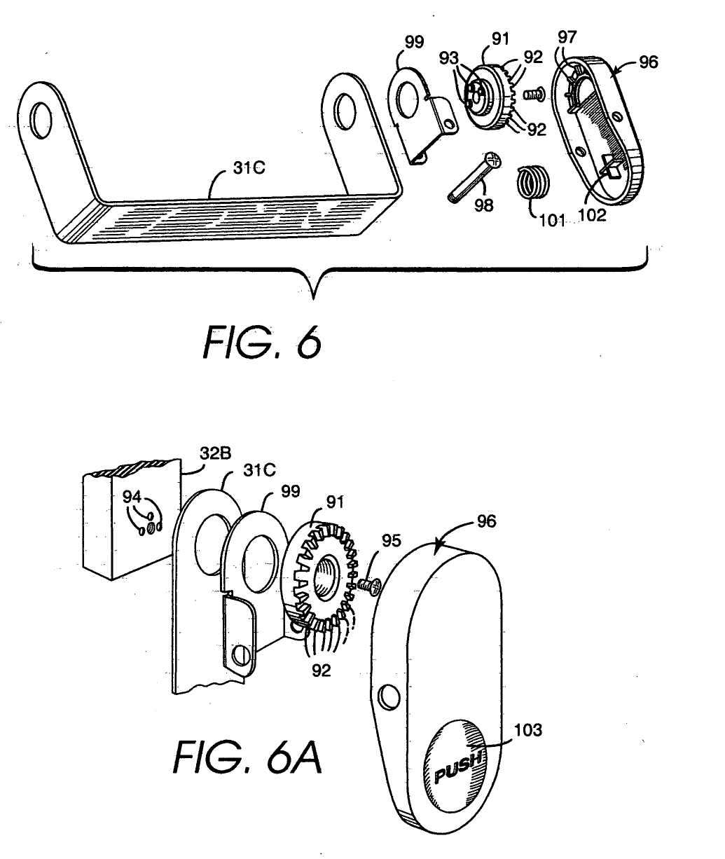

FIGS. 6 and 6A show an alternative embodiment of a detent mechanism controlling the up-and-down tilt of the worklight head about a nominal horizontal axis. This embodiment includes a toothed detent member 91, which provides a plurality of outwardly projecting teeth 92. Here the toothed detent member is wheel-shaped with teeth 92 projecting from a face of the wheel. This form is convenient for fabrication, but other shapes of toothed detent member may also be used. The teeth are spaced apart along a circular arc on the face of the wheel. In the embodiment of FIGS. 6 and 6A the individual teeth extend radially along the face of the wheel and are illustrated as having a generally box-like form as this form provides for good inter-engagement and holding power, although other forms such as sawtooth form may also be used. In the illustrated embodiment the toothed detent member is located on the worklight head by three indexing projections 93 on the back face of the wheel, which are received in corresponding index holes 94 formed in a surface on the worklight head, more particularly in a downward projecting tab 32B. Toothed wheel 91 is secured in position on downward projecting tab 32C by screw 95. A latching detent member, indicated generally at reference numeral 96, has a portion defining a plurality of latching teeth 97 arranged to interengage with teeth 92 of the toothed detent member 91. The latching member is pivoted at its mid-region about a pivot pin 98. The pivot pin in turn is mounted on a pivot-pin bracket 99. The pivot-pin bracket is secured to a vertical arm of mounting bracket 31C for example by adhering or welding and may also be indexed to the mounting bracket for ease in positioning during manufacture. In the illustrated embodiment pivot pin 98 passes through the opposed holes on the sides of the latching detent member and through the opposed holes on the wings of bracket 99. The pin is threaded on one end and screws into one of the holes on the side of the latching detent member. Thus, the pin secures the latching detent member to the pivot-pin bracket, which is secured to mounting bracket 31C. A coil spring 101 is retained on the inner surface of the latching detent member by the projection 102 and pushes against the vertical arm of mounting bracket 31C so as to cause the latching member to pivot about the pivot bar and urge teeth of the wheel and latching member into engagement with one another. The outwardly facing surface of the latching detent member has a portion 103, located generally over the coil spring, formed for engagement by a user so that a user, pressing down on the user engagement portion, causes the latching member to pivot about the pivot pin and release the toothed wheel. The user can then grasp the head by the handle on the worklight head and rotate the head about the horizontal axis until it is aimed in the desired direction, at which point the user releases the latching detent member, thereby permitting the teeth to interengage one another and hold the head in the selected position.

In the above examples the detent mechanism is sufficient to aim the worklight head and hold it in position under normal conditions of worklight usage. Nevertheless, in some embodiments it may be desirable to add an optional locking mechanism such as a frictional lock screw to be tightened by the user to lock the head in a fixed or immovable position for shipping, transportation or storage.

The above descriptions and drawings are given to illustrate examples of various aspects of the invention in various embodiments, but they are not intended to limit the invention only to these examples and illustrations. Given the benefit of the above disclosure, those skilled in the art may be able to devise various modifications and alternate constructions that although differing from the examples disclosed herein nevertheless enjoy the benefits of the invention and fall within the scope of the invention, which is to be defined by the following claims.

1. A worklight including a worklight head of at least about 1.5 pounds in weight and having an electrical cord extending therefrom for providing electrical power to said head, the head being mounted on a support so as to be rotatable about an axis for aiming the head in a desired direction, wherein the improvement is characterized in that:
said worklight includes a detent mechanism operatively associated with said head defining a plurality of fixed detent positions disposed to maintain said head in a plurality of fixed detent positions disposed to maintain said head in a plurality of angular dispositions corresponding to different angles of rotation about an axis, said head being movable between said fixed detent positions for aiming in a desired direction, the detent mechanism being biased to maintain said head in said fixed detent positions at the desired angular disposition against the weight of said head itself and the pull of said electrical cord under conditions of use.

2. The worklight of claim 1 wherein said axis is a nominal horizontal axis for aiming the head in a desired up-and-down direction, and said plurality of fixed detent positions are disposed to maintain said head in a plurality of up-and-down attitudes corresponding to different angles of rotation about said nominal horizontal axis.

3. The worklight of claim 2 wherein said detent mechanism comprises at least one spring-biased plunger.

4. The worklight of claim 3 wherein said detent mechanism comprises a plurality of individually spring-biased plungers.

5. The worklight of claim 3 further characterized in that said detent mechanism comprises a plurality of recesses arranged along a circular arc for receiving said at least one plunger as said head is rotated about said horizontal axis, wherein the disposition of said at least one plunger and said plurality of recesses defines said fixed detent positions.

6. The worklight of claim 5 wherein said plurality of recesses are formed in said support and said at least one plunger is carried by said head.

7. The worklight of claim 5 wherein said detent mechanism comprises at least two individually spring-biased plungers disposed so as to be received in two corresponding recesses for each said fixed detent position.

8. The worklight of claim 5 further characterized in that:
said detent mechanism comprises at least two individually spring-biased plungers;
said detent mechanism comprises two pluralities of recesses, a first plurality arranged along a first circular arc and a second plurality arranged along a second circular arc of different radius from said first circular arc;
a first of said at least two plungers is disposed to engage the recesses along said first circular arc;
a second of said at least two plungers is disposed to engage the recesses along said second circular arc; and
the recesses of said first and second pluralities are angularly offset from one another such that when one of said first and second plungers engages the recesses of its associated circular arc, the other of said first and second plungers is out of position to engage the recesses of its associated circular arc.

9. The worklight of claim 5 further characterized in that:
said detent mechanism comprises at least two individually spring-biased plungers disposed along said circular arc so as to be angularly offset from one another such that when one of said plungers engages a recess along said circular arc, another of said plungers is out of position to engage a recess of said arc.

10. The worklight of claim 2, further characterized in that said detent mechanism comprises:
a plurality of first teeth arranged to form recesses between neighboring teeth of said plurality;
a latching detent member having at least one tooth arranged to interengage said first teeth;
a spring-bias arrangement having a normal disposition urging said plurality of first teeth and the at least one tooth of said detent member into interengagement with one another;
said plurality of first teeth being fixed to said head and said detent member being fixed to said support;
said teeth being disposed to define a plurality of fixed detent positions when said teeth interengage one another maintaining said head in a plurality of up-and-down attitudes corresponding to different angles of rotation about said nominal horizontal axis, said head being movable between said fixed detent positions for aiming in a desired up-and-down direction;
whereby said head is maintained in said desired up-and-down attitude against the weight of said head and against the pull of said electrical cord under conditions of use.

11. The worklight of claim 10, further characterized in that:
said detent mechanism comprises a first detent member carrying said plurality of first teeth, the teeth of said first plurality extending from a surface of said first detent member; and
wherein one of said first and latching detent members is fixed to said head and the other of said first and latching detent members is fixed to said support.

12. The worklight of claim 11 wherein said latching detent member has a plurality of second teeth disposed to interengage said first teeth.

13. The worklight of claim 12 wherein
said first detent member is fixed to said head and said latching detent member is fixed to said support; and
said spring-bias arrangement normally urges said second teeth into interengagement with said first teeth.

14. The worklight of claim 13, wherein said latching detent member is formed with a user engagement surface disposed such that depressing said surface disengages said first and second teeth thereby permitting rotation of said head about said horizontal axis.

15. A worklight including a worklight head of at least about 1.5 pounds in weight and having an electrical cord extending therefrom for providing electrical power to said head, the head being connected to a generally U-shaped bracket at first and second support points on opposite sides of said head for rotation about a nominal horizontal axis through said support points for aiming the head in a desired up-and-down direction, wherein the improvement is characterized in that:
said worklight includes a detent mechanism operatively associated with said head and said bracket at at least one said support point, said detent mechanism comprising:
at least one spring-biased plunger fixed to said head;
a plurality of recesses in a side of said bracket arranged along a circular arc for receiving said at least one plunger as said head is rotated about said horizontal axis, wherein the disposition of said at least one plunger and said plurality of recesses defines said fixed detent positions;
whereby said head is maintained in said desired up-and-down attitude against the weight of said head and against the pull of said electrical cord under conditions of use.

16. The worklight of claim 15 further comprising a second said detent mechanism operating between said head and said bracket at the second of said support points.

17. A worklight including a worklight head of at least about 1.5 pounds in weight and having an electrical cord extending therefrom for providing electrical power to said head, the head being connected to a generally U-shaped bracket at first and second support points on opposite sides of said head for rotation about a nominal horizontal axis through said support points for aiming the head in a desired up-and-down direction, wherein the improvement is characterized in that:
said worklight includes a detent mechanism operatively associated with said head and said bracket at at least one said support point, said detent mechanism comprising:
a toothed detent member having a plurality of teeth, said teeth being spaced apart along a circular arc, said toothed detent member being fixed to said head at one of said support points;
a latching detent member having a plurality of teeth arranged to interengage the teeth of said wheel-shaped detent member to maintain said head in a plurality of up-and-down attitudes corresponding to different angles of rotation about said nominal horizontal axis,
said latching detent member being pivotally mounted on said bracket to move the latching detent member teeth into and out of interengagement with the wheel-shaped detent member teeth;
a spring-bias arrangement normally urging the latching detent member to pivot into a position of interengagement of said teeth; and
said latching detent member is formed with a user engagement portion disposed such that depressing said portion causes said latching detent member to pivot so as to temporarily disengage said teeth thereby permitting rotation of said head about said nominal horizontal axis;
whereby said head is maintained in said desired up-and-down attitude against the weight of said head and against the pull of said electrical cord under conditions of use.

18. A worklight including a worklight head of at least about 1.5 pounds in weight and having an electrical cord extending therefrom for providing electrical power to said head, the head being mounted on an intermediate member and the intermediate member being mounted on a support so as to be rotatable about a nominal vertical axis for aiming the head in a desired side-to-side direction, wherein the improvement is characterized in that:
said worklight includes a detent mechanism operatively associated with said intermediate member and said support and defining a plurality of fixed detent positions disposed to maintain said head in a plurality of side-to-side angular positions corresponding to different angles of rotation about said nominal vertical axis, said intermediate member being movable between said fixed detent positions for aiming said head in a desired side-to-side direction, and said detent mechanism being biased to hold said intermediate member in said fixed detent positions,
whereby said head is maintained in said desired side-to-side angular position against the weight of said head and against the pull of said electrical cord under conditions of use.

19. The worklight of claim 18 wherein said detent mechanism comprises at least one spring-biased plunger.

20. The worklight of claim 19 wherein said detent mechanism comprises a plurality of individually spring-biased plungers.

21. The worklight of claim 19 further characterized in that said detent mechanism comprises a plurality of recesses arranged along a circular arc for receiving said at least one plunger as said intermediate member is rotated about said nominal vertical axis, wherein the disposition of said at least one plunger and said plurality of recesses defines said fixed detent positions.

22. The worklight of claim 19 wherein said plurality of recesses are formed in said intermediate member and said at least one plunger is carried by said support.

23. The worklight of claim 19 wherein said detent mechanism comprises at least two individually spring-biased plungers disposed so as to be received in two corresponding recesses for each said fixed detent position.

24. The worklight of claim 19 further characterized in that:
said detent mechanism comprises at least two individually spring-biased plungers;
said detent mechanism comprises two pluralities of recesses, a first plurality arranged along a first circular arc and a second plurality arranged along a second circular arc of different radius from said first circular arc;
a first of said at least two plungers is disposed to engage the recesses along said first circular arc;
a second of said at least two plungers is disposed to engage the recesses along said second circular arc; and
the recesses of said first and second pluralities are angularly offset from one another such that when one of said first and second plungers engages the recesses of its associated circular arc, the other of said first and second plungers is out of position to engage the recesses of its associated circular arc.

25. The worklight of claim 19 further characterized in that:
said detent mechanism comprises at least two individually spring-biased plungers disposed along said circular arc so as to be angularly offset from one another such that when one of said plungers engages a recess along said circular arc, another of said plungers is out of position to engage a recess of said arc.
